(19) United States
(12) Patent Application Publication
(10) Pub. No.: US 2026/0131820 A1
(43) Pub. Date: May 14, 2026

(54) VERIFYING OBJECT RECOGNITION WITH MULTI-MODAL TEMPORAL SIMILARITY MEASURES

(71) Applicant: HRL Laboratories, LLC, Malibu, CA (US)

(72) Inventors: Hyukseong KWON, Thousand Oaks, CA (US); Rodolfo VALIENTE ROMERO, Calabasas, CA (US); Amir M. RAHIMI, Santa Monica, CA (US); Rajan BHATTACHARYYA, Sherman Oaks, CA (US)

(73) Assignee: HRL Laboratories, LLC, Malibu, CA (US)

(21) Appl. No.: 18/384,873

(22) Filed: Oct. 29, 2023

(51) Int. Cl. B60W 60/00; B60W 10/04; B60W 10/20; B60W 50/00; G06V 10/40; G06V 10/74; G06V 10/762; G06V 10/764; G06V 10/774; G06V 10/776; G06V 20/52; G06V 20/58

(52) U.S. Cl. CPC B60W 60/001; B60W 10/04; B60W 10/20; B60W 50/00; G06V 10/40; G06V 10/761; G06V 10/764; G06V 10/776; G06V 20/52; G06V 20/58; B60W 2420/403; B60W 2554/402; B60W 2554/4041; B60W 2710/20; B60W 2720/10; G06V 10/762; G06V 10/774

(57) ABSTRACT

A temporal sequence of multi-modal signals is generated from a feature probe signal, a relation probe signal, and attribute probe signal, and multi-modal signals are selected from the temporal sequence of multi-modal signals. The selected multi-modal signals are compared to a model multi-modal embedding space cluster to generate the multi-modal temporal similarity measures. The multi-modal temporal similarity measures are compared to a model similarity measure boundary to generate object recognition verification data associated with an object classification.

### TECHNICAL FIELD

This specification relates to object detection and recognition in perception systems.

### BACKGROUND

Object recognition in autonomous driving and autonomous surveillance systems depends on neighborhood situations in a scene of detected objects. Semantic information from neighboring object relations and their corresponding object attributes may be used in object recognition of detected objects in the scene. However, challenging neighborhood scenes such as vehicle traffic on a rainy night can make the object recognition vulnerable to perception errors.

### DESCRIPTION OF DRAWINGS

FIG. 1 is a diagram of an autonomous vehicle having an object recognition verifier using multi-modal temporal embedding space and similarity measures from integrated scene probes associated with a detected object, according to an embodiment.

FIGS. 2A-2C show an example of a feature probe signal and relation probe signals that change and temporally vary over time when a neighboring vehicle passes by the autonomous vehicle having the probe signal detection embodiments illustrated of FIG. 1.

FIG. 3 is a diagram illustrating an example embodiment of a similarity measure generator in the autonomous vehicle of FIG. 1.

FIG. 4 is a diagram illustrating an example embodiment of an object classification verifier in the autonomous vehicle of FIG. 1

FIG. 5 is a flow chart illustrating an example embodiment of a process for verifying object classification in a perception system.

FIG. 6 is a diagram of a computer system configured in a training phase to develop model parameters for verifying object recognition, according to an embodiment.

FIG. 7 is a flow chart illustrating mapping of multi-modal signals to create model true positive and false positive clusters during the training phase in the computer system of FIG. 6.

FIG. 8 a diagram of the computer system of FIG. 6 configured in a testing phase to test and validate the model parameters for verifying object recognition, according to an embodiment.

FIG. 9 is a flow chart illustrating Mahalanobis distance measurements of the model true positive cluster and the model false positive cluster to identify wrong classifications and confirm final classification results in the computer system of FIG. 6.

FIGS. 10A-10B illustrate performance of conventional object recognition compared to the improved performance of object recognition implementing the disclosed embodiments.

### DETAILED DESCRIPTION

The disclosed embodiments illustrate an autonomous vehicle having an object recognition verifier using multi-modal temporal embedding space and similarity measures from integrated scene probes associated with detected objects. Also, a method of verifying object classification in a perception system may be used in applications such as autonomous automotive vehicles, aircraft vehicles, and surveillance systems. Object recognition verification data may be generated to identify object classification of a detected object as a false positive (FP) classification or a true positive (TP) classification. A computer system is configured in training and testing phases to develop and validate model parameters that are used in an object recognition verifier. The object recognition verifier with trained model parameters may be used to support robust object recognition in challenging scenes that make object recognition vulnerable to perception errors. The thresholds in the various embodiments may be developed for desired performance characteristics.

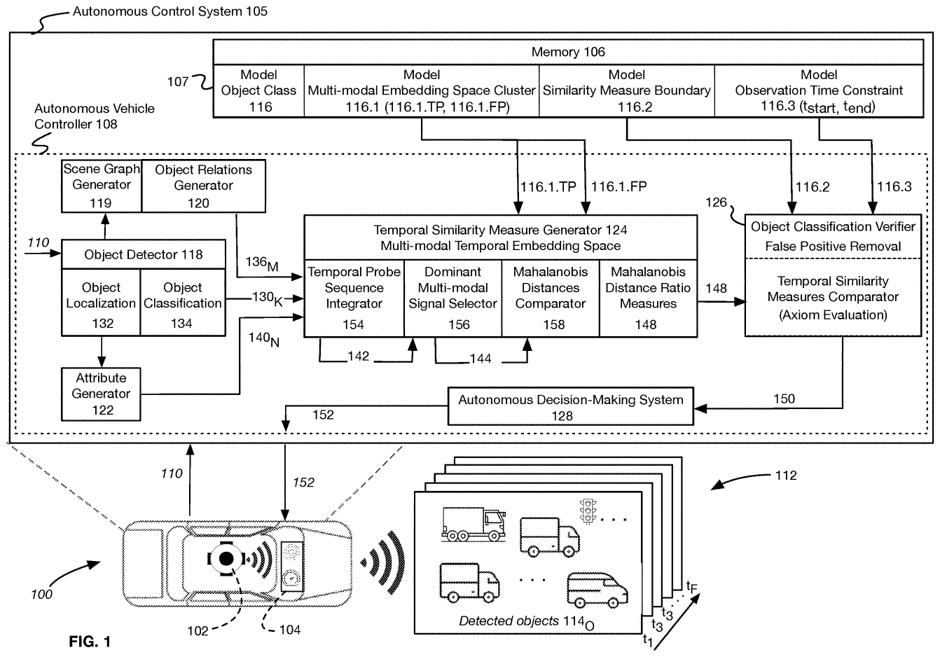

In FIG. 1, an autonomous vehicle 100 includes a sensor 102, a speed and steering control system 104, memory 106, and an autonomous vehicle controller 108. The sensor 102 is configured to provide perception data 110 that captures scene images 112 of detected objects 114_{O} during a sequence of time intervals t₁-t_{F}, where the subscript O represents the number of detected objects and the subscript F represents the number of frames. For example, sensor 102 such as a camera sensor may generate a video signal for providing perception data 110 having a sequence of frames representing captured scene images 112 of detected objects 114_{O} during the sequence of time intervals t₁ to t_{F}.

The sensor 102 may utilize other sensor modalities such as lasers, sonar, radar, and light detection and ranging (LiDAR) sensors that scan and record data from objects surrounding the autonomous vehicle 100 to provide perception data 110. In one embodiment, a measurement for the sequence of frames representing captured scene images 112 may be a predetermined time interval between frames such as every millisecond or every second, or a number of frames in a predetermined time interval such as 10 frames per second.

The memory 106 includes model object parameters 107 for at least one model object class 116 having a model multi-modal embedding space cluster 116.1 and a model similarity measure boundary 116.2. In an embodiment, the object parameters 107 further include a model observation time constraint 116.3(tₛₜₐᵣₜ, t_{end}) associated with the at least one model object class 116. The memory 106 may include object parameters 107 for a set of model object classes. Each model object class in the set of model object classes may have an associated set of a multi-modal embedding space cluster and a model similarity measure boundary. The associated set may further include a model observation time constraint tₛₜₐᵣₜ and t_{end}. The model multi-modal embedding space cluster 116.1 may include a model true positive cluster 116.1.TP and a model false positive cluster 116.1.FP.

The autonomous vehicle controller 108 includes an object detector 118, an object relations generator 120, an object attributes generator 122, a similarity measure generator 124, an object classification verifier 126, and an autonomous decision-making system 128. In an embodiment, the object relations generator 120 is a semantic relations generator.

The object detector 118 is configured to process the perception data 110 from each captured scene image 112 to generate a feature probe signal 130_{K} for each of the detected objects 114_{O}. The feature probe signal 130_{K} represents object features comprising an object localization 132 and an object classification 134 associated with the object localization 132 at each frame in the sequence of frames that are associated with a current frame fₜ^{c} and prior frames within the sequence of time intervals t₁ to t_{F}. The features probe signal 130_{K} may also represent size, aspect ratio, localization and tracking performance, and recognition confidence for the detected object 114ₒ, where the subscript o is the o^{th} detected object from O detected objects in a scene image from the scene images 112. The subscript K identifies a feature of each detected object at a time t. In an embodiment, the object detector 118 implements any suitable object detection, such as R-CNN or YOLO disclosed in S. Ren, et. al., “Faster-RCNN: Towards Real-Time Object Detection with Region Proposal Networks,” NIPS 2015, and J. Redmon, et. al., “You Only Look Once: Unified, Real-Time Object Detection,” CVPR 2016. The object detection detector 118 may also employ a suitable Simple Online and Realtime Tarcking (SORT) algorithm for object tracking, such as the DeepSORT algorithm disclosed in N. Wojke, et. al., “Simple Online and Realtime Tracking with a Deep Association Metric,” CVPR 2017.

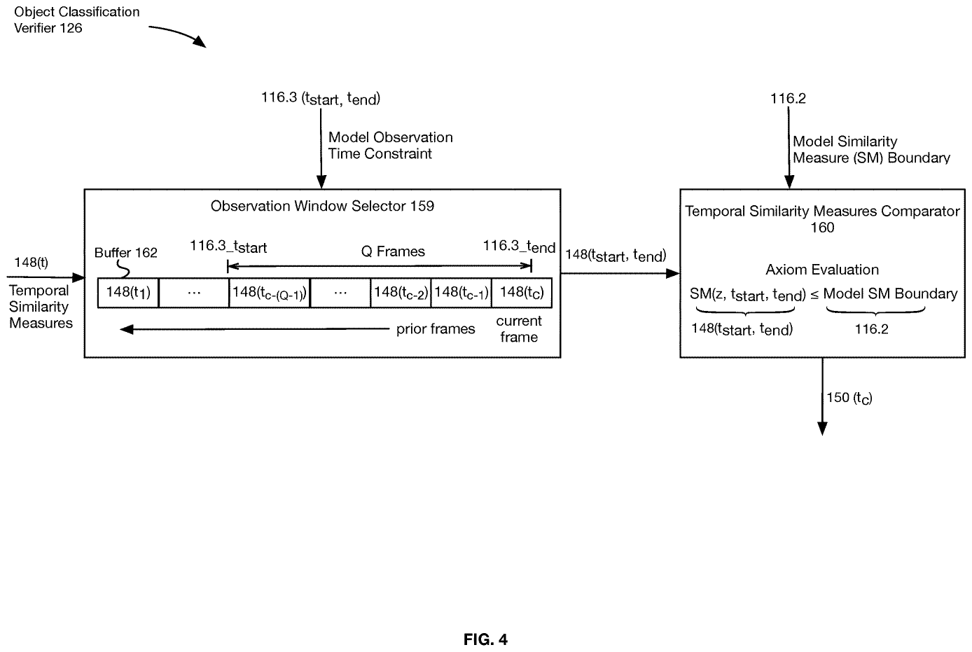

The object relations generator 120 is configured to process the object localization 132 to generate a relation probe signal 136_{M} for each of the detected objects 114_{O}. The relation probe signal 136_{M} represents object relations that satisfy a relations confidence threshold. In an embodiment, the autonomous vehicle controller 108 includes a scene graph generator 119 that is configured to process the object localization 132 to generate and provide scene graphs to the object relations generator 120. The scene graph generator 119 and the object relations generator 120 are configured to (i) capture relations R={{r₁₁, r₁₂, . . . r_{1Q}}, {r₂₁, r₂₂, . . . r_{2Q}} . . . {r_{P1}, r_{P2}, . . . r_{PQ}}} between detected actors in a scene image, where r_{pq} is the relation between the p^{th} object and the q^{th} object of the detected objects 114_{O}: (ii) filter out the subjects and objects with a certain threshold or higher: (iii) select the relations R where the class of either the subject or the object in the subject-relation-object triplet has meaningful relations, such as “HAS,” “ON”, “IN FRONT OF”, “BEHIND”; and (iv) for each i^{th} subject, retain M relations which have high confidence both on the objects and the corresponding relations. The subscript M identifies an M relation between detected objects at a time t. Examples of scene graph and object relations generation are disclosed in R. Zellers, et. al., “Neural Motifs: Scene Graph Parsing with Global Context,” CVPR 2018, J. Yang, et. al., “Graph R-CNN for Scene Graph Generation,” ECCV 2018, and Y. Li, et. al., “Scene Graph Generation from Objects, Phrases, and Region Captions,” ICCV 2017. In an embodiment, each selected M relation may be generated using probabilistic signal temporal logic (PSTL) such as the PSTL illustrated in the embodiment of FIG. 4.

The object attributes generator 122 is configured to process the object localization 132 to generate an attribute probe signal 140_{N} for each of the detected objects 114_{O}. The attribute probe signal 140_{N} represents object attributes that satisfy an attributes confidence threshold. The attributes may be determined with scores such as confidence values for each detected object 114ₒ. For example, the N attributes may include “RED,” “WET,” or “REFLECTIVE” for the detected objects. For each detected object 114ₒ, the top N attributes are collected to define the detected object 114ₒ. The subscript N identifies an attribute of each detected object at a time t.

The similarity measure generator 124 is configured to (i) integrate the feature probe signal 130_{K}, the relation probe signal 136_{M}, and the attribute probe signal 140_{N} into a temporal sequence of integrated multi-modal signals 142: (ii) select dominant multi-modal signals 144 from the temporal sequence of integrated multi-modal signals 142 which satisfy a signal magnitude and time window threshold; and (iii) compare the selected dominant multi-modal signals 144 to the model true positive cluster 116.1.TP and the model false positive cluster 116.1.FP to generate a sequence of multi-modal temporal similarity measures 148. The sequence of multi-modal temporal similarity measures 148 are associated with the sequence of frames representing captured scene images 112 of detected objects 114_{O} during the sequence of time intervals t₁ to t_{F} that include the current frame

$${f}_{t}^{c}$$

and prior frames within the sequence of time intervals t₁ to t_{F}.

The object classification verifier 126 is configured to compare the sequence of temporal similarity measures 148 to the model similarity measure boundary 116.2 to generate object recognition verification data 150 associated with the object classification 134. In an embodiment, the object classification verifier 126 is configured to compare (a) a sequence of multi-modal temporal similarity measures 148 during the model observation time constraint 116.3(tₛₜₐᵣₜ, t_{end}) to (b) the model similarity measure boundary 116.2 for generating the object recognition verification data 150 associated with the object classification 134. The model observation time constraint 116.3(tₛₜₐᵣₜ, t_{end}) comprises the observation start time 116.3_tₛₜₐᵣₜ and the observation end time 116.3_t_{end} for observing frames between the current time frame

$${f}_{t}^{c}$$

and prior names within sequence of time intervals t₁ to t_{F}.

The object recognition verification data 150 may identify the object classification 134 (i) as a false positive classification when the sequence of temporal similarity measures 148 does not satisfy the model similarity measure boundary 116.2 and (ii) as a true positive classification when the sequence of temporal similarity measures 148 satisfies the model similarity measure boundary 116.2. The model object class 116 is selected based on the object classification 134 from the object detector 118.

The autonomous decision-making system 128 is configured to process the object recognition verification data 150 for generating a decision-making command 152. The speed and steering control system 104 is configured to processes the decision-making command 152 to autonomously maneuver the autonomous vehicle 100.

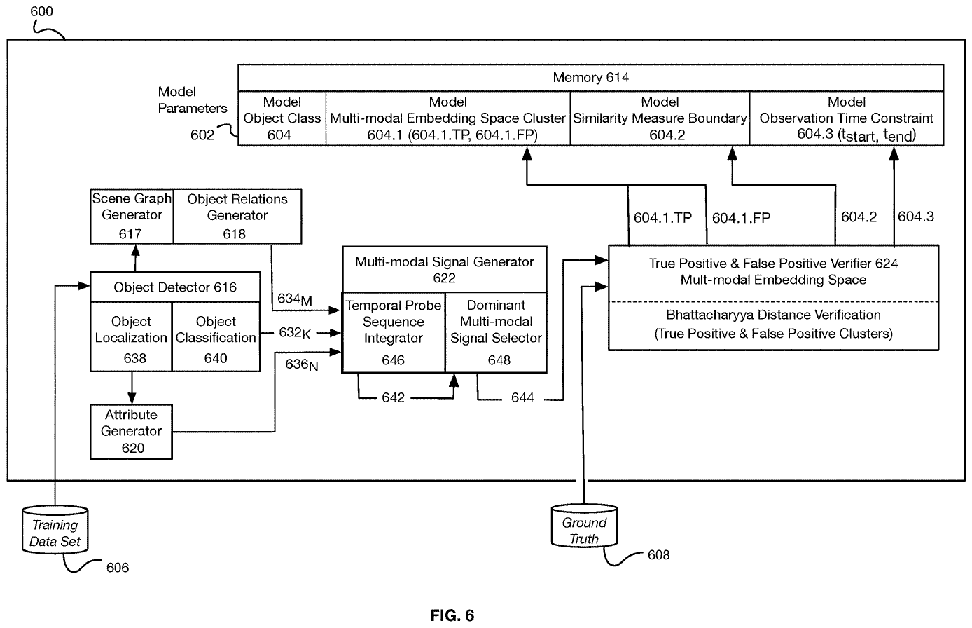

In an embodiment, the autonomous vehicle 100 may include an autonomous control system 105 that includes the autonomous vehicle controller 108 and the memory 106, and the memory 106 may be integrated in the autonomous vehicle control system 108. The model parameters 107 for a set of model object classes may be determined from neural network or machine learning model training and testing, such as the training and testing illustrated in FIGS. 6-9, and may be provided by a wired or wireless connection to the autonomous control system 105.

The similarity measure generator 124 may include a temporal sequence integrator 154, a dominant multi-modal signal selector 156, and a Mahalanobis distances comparator 158. The similarity measure generator 124 may further include a buffer for storing the sequence of multi-modal temporal similarity measures 148. Alternatively, the object classification verifier 126 may include a buffer for storing the sequence of multi-modal temporal similarity measures 148.

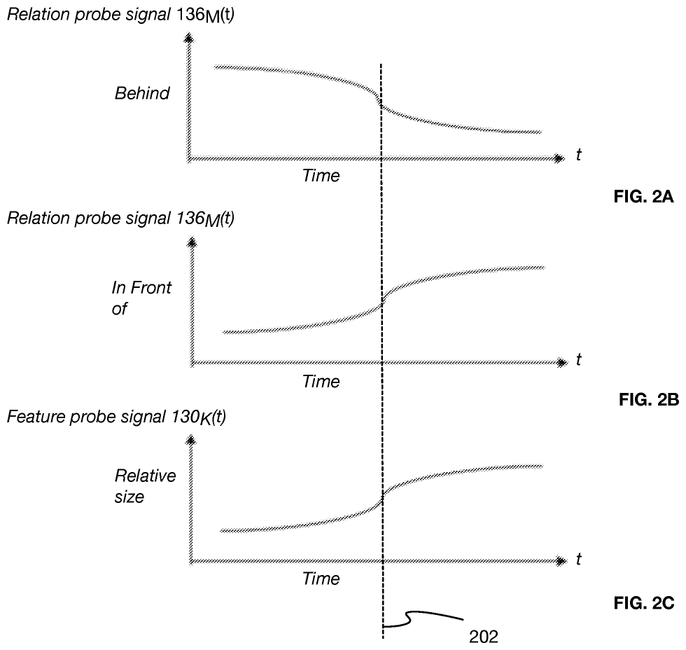

Each of the K features, M relations, and N attributes respectively associated with feature probe signal 132_{K}, the relation probe signal 138M, and the attribute probe signal 140_{N} may be consistent or temporally varying over time. FIGS. 2A-2C show an example of two relation probe signals 136_{M}(t) respectively representing “Behind” and “In front Of” (FIGS. 2A and 2B) and a feature probe signal 130_{M}(t) representing “Relative Size” (FIG. 2C). Each of the probe signals are illustrated as changing and temporally varying over time such as shown at time 202 when a neighboring vehicle passes by an autonomous vehicle that includes the probe signal detection embodiments illustrated in the autonomous vehicle 100 of FIG. 1.

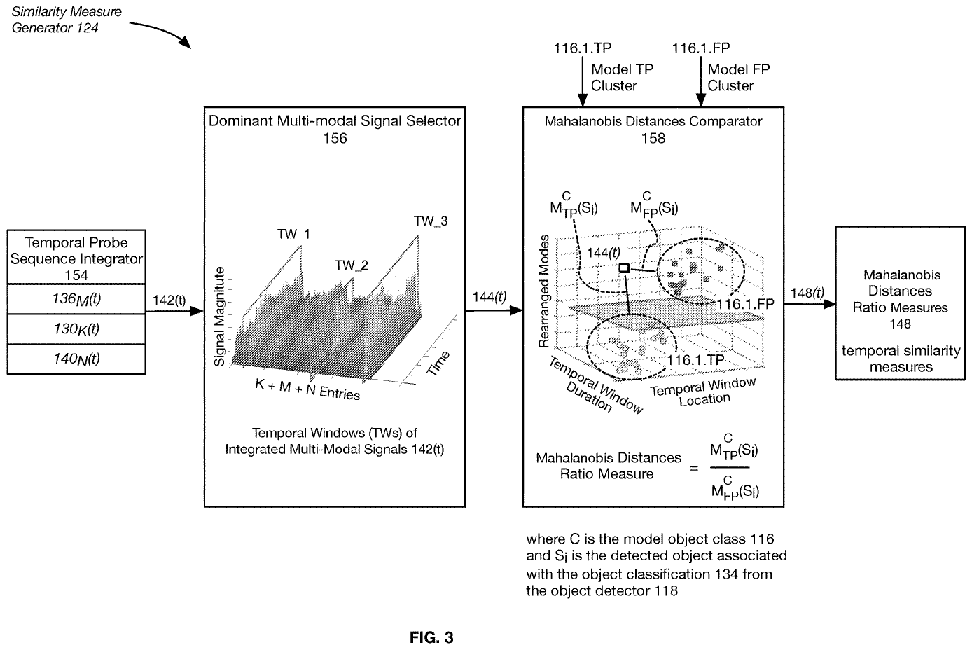

In FIG. 3, the temporal probe sequence integrator 154 is configured to integrate the feature probe signal 130_{K}(t), the relation probe signal 136_{M}(t), and the attribute probe signal 140_{N}(t) into the temporal sequence of integrated multi-modal signals 142(t). In the dominant multi-modal signal selector 156, each of the integrated multi-modal signals 142(t) has a respective temporal window (TW) that corresponds to one of the feature probe signal 130_{K}(t), the relation probe signal 136_{M}(t), or the attribute probe signal 140_{N}(t) received from the temporal probe sequence integrator 154. The dominant multi-modal signal selector 156 selects the dominant multi-modal signals 144(t) from the temporal sequence of integrated multi-modal signals 142(t) which satisfy a signal magnitude and time window threshold. The signal magnitude and time window threshold defines a signal magnitude strength and a time window period of the selected dominant multi-modal signals 144(t) for generating the sequence of multi-modal temporal similarity measures 148(t) in the Mahalanobis distances comparator 158. For illustration, the selected dominant multi-modal signals 144(t) are shown as TW_1, TW_2, and TW_3 in an embodiment of the dominant multi-modal signal selector 156.

In the Mahalanobis distances comparator 158, the selected dominant multi-modal signals 144(t) are mapped to a point in a temporal embedding space. The Mahalanobis distances comparator 158 is configured to (i) compare the selected multi-modal signals 144(t) to the model true positive cluster 116.1.TP to determine a true positive distance measure

$${M}_{TP}^{C}$$

(Sᵢ) and (ii) compare the selected dominant multi-modal signals 144(t) to the model false positive cluster 116.1.FP to determine a false positive distance measure

$${M}_{FP}^{C}$$

(Sᵢ), where in this function the index C represents the model object class 116 and the index Sᵢ represents the detected object associated with the object classification 134. The multi-modal temporal similarity measure 148(t) is a ratio of the Mahalanobis distances

$$\frac{{M}_{TP}^{C} ( {S}_{i} )}{{M}_{FP}^{C} ( {S}_{i} )} .$$

In FIG. 4, the objection classification verifier 126 includes an observation window selector 159 and a temporal similarity measure comparator 160. The observation window selector 159 is configured to (a) receive the sequence of multi-modal temporal similarity measures 148(t) from the similarity measure generator 124 of FIG. 1 and (b) select an observation sequence of temporal similarity measures 148(tₛₜₐᵣₜ, t_{end}). The sequence of multi-modal temporal similarity measures 148(t) from the similarity measure generator 124 may be stored in a buffer 162, and includes a similarity measure 148(t_{c}) at the current frame

$${f}_{t}^{c}$$

and similarity measures 148(t_{c-1}), 148(t_{c-2}) . . . 148(t₁) at the prior frames within the sequence of time intervals t₁ to t_{F}. The time t_{c} corresponds to the current frame

$${f}_{t}^{c}$$

in the sequence of time intervals of t₁ to t_{F}. The selected observation sequence of temporal similarity measures 148(tₛₜₐᵣₜ, t_{end}) is associated with the current frame

$${f}_{t}^{c}$$

and prior frames within the model observation start time 116.3_tₛₜₐᵣₜ and the model observation end time 116.3_t_{end}. The model observation time constraint 116.3(tₛₜₐᵣₜ, t_{end}) provides boundaries for Q frames that define the current time frame

$${f}_{t}^{c}$$

and the prior frames during the sequence of time intervals t₁ to t_{F} associated with the scene images 112. In one embodiment, the buffer 162 is configured to store the Q frames.

The temporal similarity measures comparator 160 is configured to determine the object verification data 150 (t_{c}) from combined similarity measures 148(t) and probabilistic signal temporal logic constraints based on (i) the selected observation sequence of similarity measures 148(tₛₜₐᵣₜ, t_{end}) during the current frame

$${f}_{t}^{c}$$

and the prior frames within model observation time constraint 116.3 and (ii) the model temporal similarity boundary 116.2 associated with the model object class 116.

The temporal similarity measures comparator 160 determines the object verification data 150(t_{c}) represents a verified classification at the current frame

$${f}_{t}^{c} .$$

The object verification data 150(t_{c}) represents a verified classification at the current frame

$${f}_{t}^{c}$$

when the selected observation sequence of similarity measures 148(tₛₜₐᵣₜ, t_{end}) associated with the detected object 114ₒ during the model observation time constraint 116.3(tₛₜₐᵣₜ, t_{end}) is within the model temporal similarity measure boundary 116.2. The object verification data 150 (t_{c}) represents a misclassification at the current frame

$${f}_{t}^{c}$$

when the selected observation sequence of similarity measures 148(tₛₜₐᵣₜ, t_{end}) associated with the detected object 114ₒ during the model observation time constraint 116.3(tₛₜₐᵣₜ, t_{end}) i not within the model temporal similarity measure boundary 116.2.

In an embodiment, the combined similarity measures 148(t) and probabilistic signal temporal logic (PSTL) constraints is generated as follows:

$$∀ z , Pr ( SM ( z , {t}_{start} , {t}_{end} ) \leq {SM}_{boundary} \to the model object class 116 )$$

where:
Pr(⋅) is a predicate;
SM(z, tₛₜₐᵣₜ, t_{end}) is the observation z of the sequence of similarity measures (SM) 148(t) during a sequence of frames including the current frame

$${f}_{t}^{c}$$

and the prior frames within the model observation time constraint 116.3(tₛₜₐᵣₜ,t_{end}) associated with the model object class 116;
SM_boundary represents performance characteristics from model similarity measure sequences within the model observation time constraint 116.3(tₛₜₐᵣₜ, t_{end}) for the selected model object class 116, where the performance characteristics reflect verified object detection characteristics for instances of similarity measure sequences within the time constraint 116.3(tₛₜₐᵣₜ,t_{end}) associated with model object class 116; and
the symbol “≤” refers to SM(z, tₛₜₐᵣₜ, t_{end}) being within SM_boundary for determining the validation measurement associated with the object classification 134 at the current frame

$${f}_{t}^{c} .$$

The object recognition verification data 150 (t_{c}) represents a validation measurement for the object classification 134 at the current frame

$${f}_{t}^{c} .$$

The validation measurement is a comparison of (a) the selected observation sequence of similarity measures 148(tₛₜₐᵣₜ, t_{end}) at the current frame

$${f}_{t}^{c}$$

and the prior frames within the observation start time 116.3 tₛₜₐᵣₜ and the observation end time 116.3 t_{end} and (b) the model temporal similarity measure boundary 116.2 associated with the model object class 116.

The validation measurement for the object classification 134 at the current frame

$${f}_{t}^{c}$$

is a verified classification when the selected observation sequence of temporal similarity measures 148(tₛₜₐᵣₜ, t_{end}) associated with the detected object 114ₒ at the current frame

$${f}_{t}^{c}$$

and the prior frames during the model observation time constraint 116.3(tₛₜₐᵣₜ,t_{end}) is within the modal temporal similarity measure boundary 116.2 associated with the model object class 116.

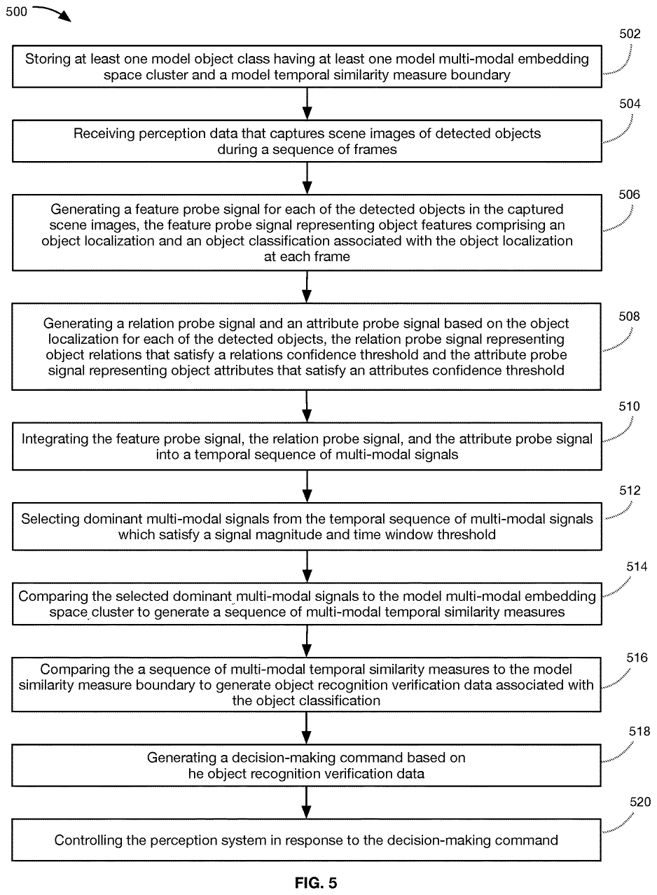

FIG. 5 is a method 500 for verifying objection classification in a perception system. Step 502 stores at least one model object class having a model multi-modal embedding space cluster and a model similarity measure boundary. Step 504 receives perception data that captures scene images of detected objects during a sequence of frames. Step 506 generates a feature probe signal for each of the detected objects in the captured scene images. The feature probe signal represents object features comprising an object localization and an object classification associated with the object localization. Step 508 generates a relation probe signal and an attribute probe signal based on the object localization for each of the detected objects. The relation probe signal represents object relations that satisfy a relations confidence threshold. The attribute probe signal represents object attributes that satisfy an attributes confidence threshold. Step 510 integrates the feature probe signal, the relation probe signal, and the attribute probe signal into a temporal sequence of multi-modal signals. Step 512 selects dominant multi-modal signals from the temporal sequence of multi-modal signals which satisfy a signal magnitude and time window threshold. Step 514 compares the selected dominant multi-modal signals to the model multi-modal embedding space cluster to generate a sequence of multi-modal temporal similarity measures associated with the sequence of frames. Step 516 compares the sequence of temporal similarity measures to the model similarity measure boundary to generate object recognition verification data associated with the object classification. Step 518 generates a decision-making command based on the object recognition verification data. Step 520 controls the perception system in response to the decision-making command.

In an embodiment, the perception system may be embedded in an autonomous vehicle that includes (i) a sensor and (ii) a speed and steering control system, and the step 520 of controlling the perception system includes controlling the speed and control system in response to the decision-making command for autonomously maneuvering the autonomous vehicle. Alternatively, the perception system is embedded in an autonomous security system that includes a surveillance system, and the step of controlling the perception system includes controlling the surveillance system in response to the decision-making command for autonomously controlling the aviation security system. For example, the autonomous security system may be an autonomous aviation security system.

The object recognition verification data identifies the object classification (i) as a false positive classification when the multi-modal temporal similarity measure does not satisfy the model similarity measure boundary and (ii) as a true positive classification when the multi-modal temporal similarity measure satisfies the model similarity measure boundary.

The embodiments illustrated in the autonomous vehicle 100 of FIG. 1 may also be embodiments in the method 500 for verifying objection classification in a perception system. For example, the at least one model object class may be a set of model object classes. Each model object class in the set of model object classes may have an associated set of a multi-modal embedding space cluster and a model similarity measure boundary. The associated set may further include a model observation time constraint. A model object class from the set of model object classes is selected based on the object classification. In an embodiment, the model multi-modal embedding space cluster may include a model true positive cluster and a model false positive cluster in a temporal embedding space. The selected multi-modal signals are mapped to a point in the temporal embedding space, and are compared to (i) the model true positive cluster to determine a true positive distance measure and (ii) the model false positive cluster to determine a false positive distance measure in the embedding space. The multi-modal temporal similarity measure is a ratio of the true positive distance and the false positive distance.

A selected sequence of multi-modal temporal similarity measures within the model observation time constraint may be compared to the model similarity measure boundary for generating the object recognition verification data associated with the object classification. The sequence of frames has a current frame and prior frames, and the model observation time constraint comprises an observation start time tₛₜₐᵣₜ and an observation end time t_{end}. The object recognition verification data represents a validation measurement for the object classification at the current frame. The validation measurement is a comparison of (i) the sequence of similarity measures at the current frame and the prior frames within the observation start time tₛₜₐᵣₜ and the observation end time t_{end} and (ii) the model temporal similarity measure boundary associated with the at least one model object class. The validation measurement for the object classification is a verified classification when the sequence of similarity measures associated with the detected object at the current frame and the prior frames during the model observation time constraint is within the modal temporal similarity measure boundary associated with the at least model object class.

The validation measurement for the object classification at the current frame may be determined from combined similarity measures and probabilistic signal temporal logic constraints based on (i) the sequence of similarity measures during the current frame and the prior frames within the model observation time constraint; and (ii) the model temporal similarity boundary associated with the model object class. The validation measurement represents a verified classification at the current frame when the sequence of similarity measures associated with the detected object during the model observation time constraint is within the model temporal similarity measure boundary. The validation measurement represents a misclassification at the current frame when the sequence of similarity measures associated with the detected object during the model observation time constraint is not within the model temporal similarity measure boundary. The combined similarity measures with probabilistic signal temporal logic constraints may be generated using the logic constraint illustrated in FIG. 4.

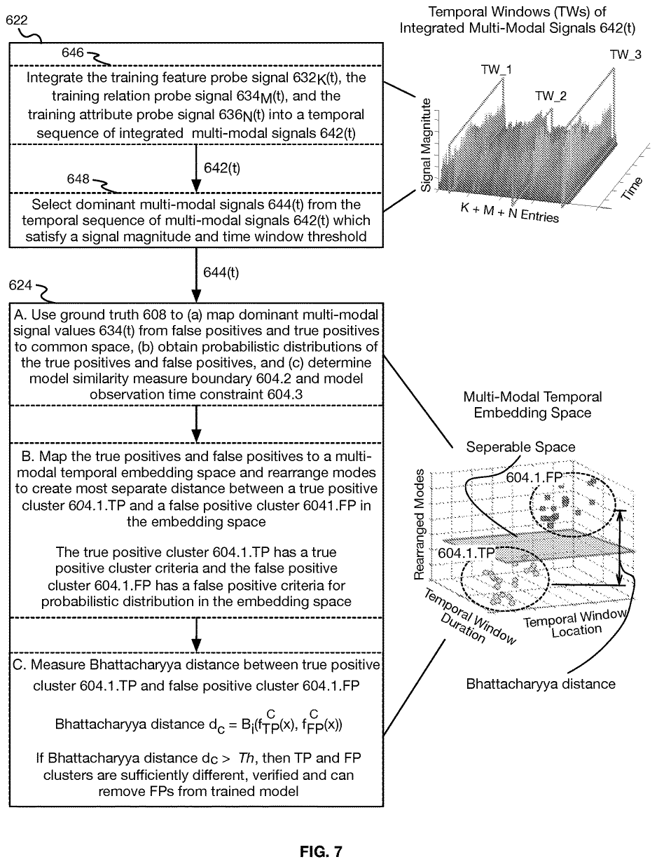

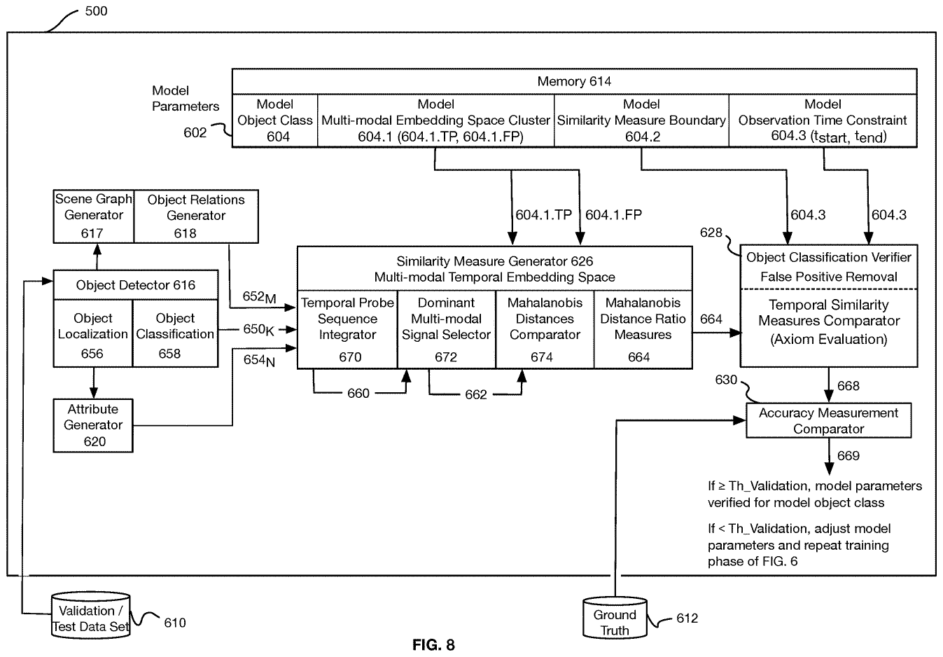

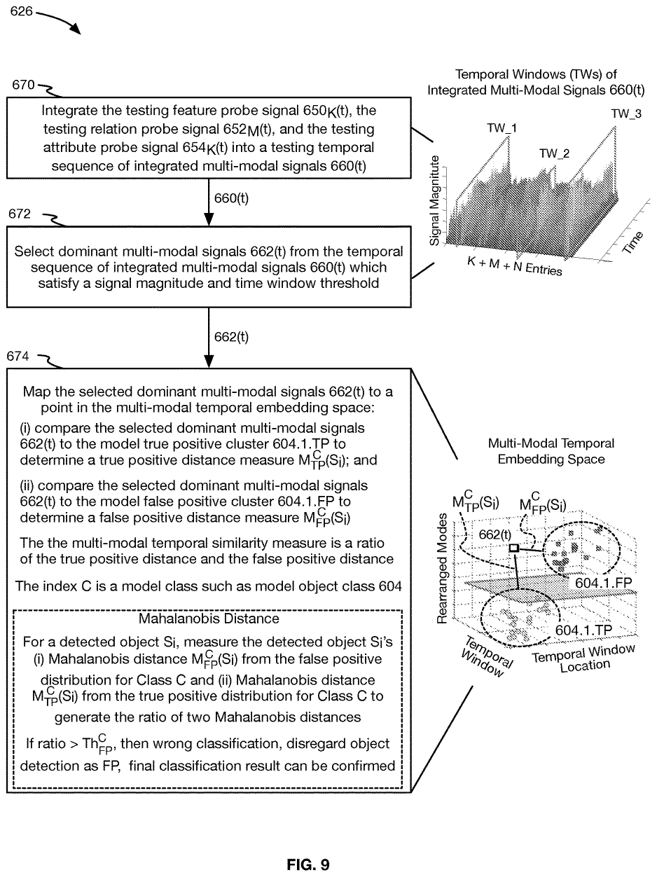

In FIGS. 6-9, a computer system 600 develops model parameters 602 for a selected model object class 604 to verify object recognition. The model parameters 602 are (a) trained using a training data set 606 and ground truth 608 during the training phase in FIGS. 5-6, and (b) verified using a validation/test data set 610 and the ground truth 612 during the testing phase in FIGS. 7-8. In an embodiment, the model parameters 602 for the selected model object class 604 are developed for the at least one model object class 116 in the autonomous vehicle 100 of FIG. 1. For both the training phase and the testing phase, the computer system 600 includes a memory 614, an object detector 616, an object relations generator 618 and an object attributes generator 620. The computer system 600 further includes a multi-modal signal generator 622 and a True Positive (TP) & False Positive (FP) Verifier 624 for the training phase in FIGS. 6-7, and a similarity measure generator 626, an object classification Verifier 628, and an accuracy measurement comparator 630 for the testing phase in FIGS. 8-9.

In FIG. 6, the object detector 616, the object relations generator 618, and the object attributes generator 620 are each configured to respectively generate a training feature probe signal 632_{K}, a training relation probe signal 634_{M}, and a training attribute probe signal 636_{N} for each detected object in scene images from the training data set 606 for the selected model object class 604. The training feature probe signal 632_{K} represents object features comprising an object localization 638 and an object classification 640 associated with the object localization 638. The training relation probe signal 634_{M} represents object relations that satisfy a relations confidence threshold. The training attribute probe signal 636_{N} represents object attributes that satisfy an attributes confidence threshold.

The computer system 600 may further include a scene graph generator 617 that is configured to process the object localization 638 to generate and provide scene graphs to the object relations generator 618. The object detector 616, the scene graph generator 617, the object relations generator 618, and the object attributes generator 620 may each be configured to have the same or equivalent structure, functions, and processes as the respective object detector 118, the scene graph generator 119, the object relations generator 120, and the object attributes generator 122 in the embodiments of the autonomous vehicle 100 of FIG. 1.

The multi-modal signal generator 622 is configured in the training phase to process the training feature probe signal 632_{K}, the training relation probe signal 634_{M}, and the training attribute probe signal 636_{N} to (i) generate a temporal sequence of integrated multi-modal signals 642 and (ii) select dominant multi-modal signals 644 from the temporal sequence of integrated multi-modal signals 642. The true positive and false positive verifier 624 is configured in the training phase to process the selected dominant multi-modal signals 644 to generate the model parameters 602 for the selected model object class 604 based on the ground truth data 608.

The model object parameters 602 for the selected model object class 604 include (i) a model multi-modal embedding space cluster 604.1, a model similarity measure boundary 604.2, and a model observation time constraint 604.3. The model multi-modal embedding space cluster 604.1 includes a model true positive cluster 604.1.TP and a model false positive cluster 604.1.FP in a temporal embedding space. In an embodiment, the model object parameters 602 include model object parameters for a set of model object classes, each model object class having an associated set of (a) a multi-modal embedding space cluster, (b) a model similarity measure boundary, and (c) an observation time constraint tₛₜₐᵣₜ and t_{end}, according to an embodiment.

In an embodiment, the multi-modal signal generator 622 may include a temporal probe sequence integrator 646 and a dominant multi-modal signal selector 648. Referring to FIG. 7, the temporal sequence integrator 646 is configured to integrate the training feature probe signal 632_{K}(t), the training relation probe signal 634_{M}(t), and the training attribute probe signal 636_{N}(t) into the temporal sequence of integrated multi-modal signals 642 (t). In the dominant multi-modal signal selector 648, each of the multi-modal signals 642 (t) has a respective temporal window (TW) that corresponds to one of the training feature probe signal 632_{K}(t), the training relation probe signal 634_{M}(t), or the training attribute probe signal 636_{N}(t) received from the temporal probe sequence integrator 646. The dominant multi-modal signal selector 648 selects the dominant multi-modal signals 644 (t) from the temporal sequence of integrated multi-modal signals 642 (t) which satisfy a signal magnitude and time window threshold. For illustration, the selected dominant multi-modal signals 644 (t) are shown as TW_1, TW_2, and TW_3 in an embodiment of the dominant multi-modal signal selector 648. The true positive & false positive verifier 624 is configured to use ground truth 608 to (i) map dominant multi-modal signal values 644 (t) from false positives and true positives to a common space: (ii) obtain probabilistic distributions of the true positives and false positives; and (ii) determine model similarity measure boundary 604.2 and model observation time constraint 604.3(tₛₜₐᵣₜ, t_{end}).

The true positive & false positive verifier 624 is configured to map the true positives and false positives to a multi-modal embedding space and rearrange modes to create most separate distance between a model true positive cluster 604.1.TP and a model false positive cluster 604.1.FP in the embedding space. The model true positive cluster 604.1.TP has an associated true positive cluster criteria and the model false positive cluster 604.1.FP has an associated false positive criteria for probabilistic distribution in the embedding space. The true positive & false positive verifier 624 is configured to measure a Bhattacharyya distance de between the model true positive cluster 604.1.TP and the model false positive cluster 604.1.FP:

$${d}_{C} = {B}_{i} ( {f}_{TP}^{C} ( x ) , {f}_{FP}^{C} ( x ) )$$

If the Bhattacharyya distance dc>Th, then the model true positive cluster 604.1.TP and the model false positive cluster 604.1.FP are sufficiently different and verified, and false positives can be removed from trained model.

In FIG. 8, the object detector 616, the object relations generator 618, and the object attributes generator 620 are each configured to respectively generate a testing feature probe signal 650_{K}, a testing relation probe signal 652_{M}, and a testing attribute probe signal 654_{N} for each detected object in scene images from the validation/test data set 610 for the selected model object class 604. The testing feature probe signal 650_{K} represents object features comprising an object localization 656 and an object classification 658 associated with the object localization 656. The testing relation probe signal 652_{M} represents object relations that satisfy a relations confidence threshold. The testing attribute probe signal 654_{N} represents object attributes that satisfy an attributes confidence threshold.

The temporal similarity measure generator 626 is configured in the testing phase to process the testing feature probe signal 650_{K}, the testing relation probe signal 652_{M}, and the testing attribute probe signal 654_{N} to (i) generate a temporal sequence of integrated multi-modal signals 660; (ii) select dominant multi-modal signals 662 from the temporal sequence of integrated multi-modal signals 660; and (iii) compare the selected dominant multi-modal signals 662 to the model true positive cluster 604.1.TP and the model false positive cluster 604.1.FP to generate a sequence of temporal similarity measures 664.

The object classification verifier 628 is configured in the testing phase to compare the sequence of temporal similarity measures 664 within the model observation time constraint 604.3(tₛₜₐᵣₜ, t_{end}) to the model similarity measure boundary 604.2 to generate an object recognition verification data 668. The accuracy measurement comparator 630 is configured to compare the object recognition verification data 668 to the ground truth 612 to determine a testing accuracy percentage 669. The model parameters 602 for the selected model object class 604 are verified if the testing accuracy percentage 669 satisfies a validation threshold. If the testing accuracy percentage 669 does not satisfy the validation threshold, the model parameters 602 for the selected object class 604 are adjusted, and the training phase of the computer system 600 in FIG. 6 is repeated followed by the testing phase of the computer system 600 in FIG. 8. In an embodiment, the object classification verifier 628 includes a temporal similarity measures comparator that is configured to have the same or equivalent structure, functions, and processes of the temporal similarity measures comparator 160 for the autonomous vehicle 100 in the embodiment of FIG. 4.

The multi-modal signal generator 626 may include a temporal probe sequence integrator 670, a dominant multi-modal signal selector 672, and a Mahalanobis distances comparator 674. Referring to FIG. 9, the temporal probe sequence integrator 670 is configured to integrate the testing feature probe signal 650_{K}(t), the testing relation probe signal 652_{M} (t), and the testing attribute probe signal 654× (t) into the temporal sequence of integrated multi-modal signals 660 (t). In the dominant multi-modal signal selector 672, each of the multi-modal signals 660 (t) has a respective temporal window (TW) that corresponds to one of the feature probe signal 650_{K}(t), the relation probe signal 652_{M} (t), and the attribute probe signal 654_{N}(t) received from the temporal probe sequence integrator 670. The dominant multi-modal signal selector 672 selects the dominant multi-modal signals 662 (t) from the temporal sequence of integrated multi-modal signals 660 (t) which satisfy a signal magnitude and time window threshold. The signal magnitude and time window threshold defines a signal magnitude strength and a time window period of the selected dominant multi-modal signals 662 (t) for generating a temporal similarity measure 664 (t) in the Mahalanobis distances comparator 674 during the testing phase. For illustration, the selected dominant multi-modal signals 662 (t) are shown as TW_1, TW_2, and TW_3 in an embodiment of the dominant multi-modal signal selector 672.

In the Mahalanobis distances comparator 674, the selected dominant multi-modal signals 662(t) are mapped to a point in a temporal embedding space. The Mahalanobis distances comparator 674 is configured to (i) compare the selected multi-modal signals 662 (t) to the model true positive cluster 604.1.TP to determine a true positive distance measure

$${M}_{TP}^{C}$$

(Sᵢ) and (ii) compare the selected dominant multi-modal signals 662 (t) to the model false positive cluster 604.1.FP to determine a false positive distance measure

$${M}_{FP}^{C}$$

(Sᵢ), where in this function, C represents the model object class 604 and Sᵢ represents the detected object associated with the object classification 658. The multi-modal temporal similarity measure 664 is a ratio of the Mahalanobis distances

$$\frac{{M}_{TP}^{C} ( {S}_{i} )}{{M}_{FP}^{C} ( {S}_{i} )} .$$

For the detected object, Sᵢ, if the ratio of the two Mahalonobis distances is larger than a threshold, Th_{FP}, then disregard the corresponding object detection as a false positive, where Th_{FP} is acquired experimentally during the modeling process:

$$Wrong object classification if \frac{{M}_{TP}^{C} ( {S}_{i} )}{{M}_{FP}^{C} ( {S}_{i} )} > {Th}_{FP}^{C} where {Th}_{FP}^{C}$$

is the corresponding ratio threshold for C, the model object class 604, which determines whether the detected object, Sᵢ, has a wrong classification by the object detector 616.

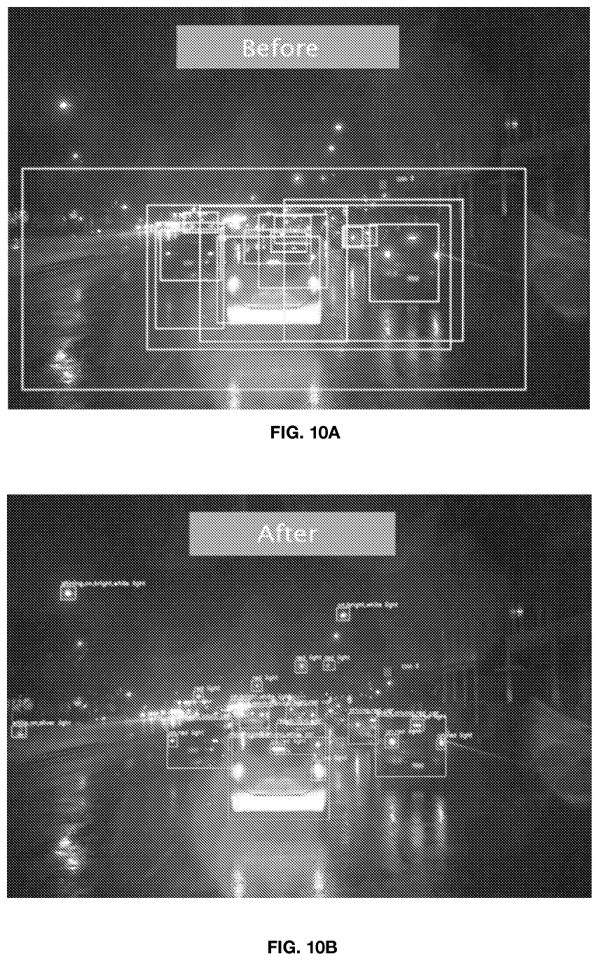

FIGS. 10A-10B illustrate test performance results that compare conventional object recognition (FIG. 10A) to the improved performance of object recognition implementing the disclosed embodiments (FIG. 10B). The test parameters include: (1) sampling driving videos of BDD-100K dataset from Berkeley DeepDrive dataset (https://bdd-data.berkeley.edu/): (2) testing dataset samples of vehicle detection on rainy night driving scenes for challenging situations; and (3) focusing on vehicle detections along with light detections (cars' tail lights, traffic lights, etc.). For relations, “NEAR-BY,” “IN FRONT OF,” and “BEHIND” are examples of relations that can help determine vehicles' detections and “ON” and “HAS” are relations between lights and vehicles. For attributes, “REFLECTED” and “WET” are example attributes that can help filter out wrong detections caused by reflections (mostly from the ground). The performance of vehicle detection precision in FIG. 10B increased by 32.15% and the number of false positives reduced by 38.85%.

One or more computer systems may be used for implementing the example embodiments in FIGS. 1-10. The computer system may comprise one or more processors configured to perform calculations, processes, operations, and/or functions associated with a program or algorithm. The processes and steps in the example embodiments may be instructions (e.g., software program) that reside within a non-transitory computer readable memory executed by the one or more processors of the computer system. When executed, these instructions cause the computer system to perform specific actions and exhibit specific behavior for the example embodiments disclosed herein. The processors may include one or more of a single processor or a parallel processor, an application-specific integrated circuit (ASIC), programmable logic array (PLA), complex programmable logic device (CPLD), or a field programmable gate array (FPGA).

The computer system may be configured to utilize one or more data storage units such as a volatile memory unit (e.g., random access memory or RAM such as static RAM, dynamic RAM, etc.) coupled with address/data bus. Also, the computer system may include a non-volatile memory units (e.g., read-only memory (“ROM”), programmable ROM (“PROM”), erasable programmable ROM (“EPROM”), electrically erasable programmable ROM “EEPROM”), flash memory, etc.) coupled with an address/data bus. A non-volatile memory unit may be configured to store static information and instructions for a processor. Alternatively, the computer system may execute instructions retrieved from an online data storage unit such as in Cloud computing.

The computer system may include one or more interfaces configured to enable an interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology. The computer system may include an input device configured to communicate information and command selections to a processor. Input device may be an alphanumeric input device, such as a keyboard, that may include alphanumeric and/or function keys. The computer system may further include a cursor control device configured to communicate user input information and/or command selections to a processor. The cursor control device may be implemented using a device such as a mouse, a track-ball, a track-pad, an optical tracking device, or a touch screen. The cursor control device may be directed and/or activated via input from an input device, such as in response to the use of special keys and key sequence commands associated with the input device. Alternatively, the cursor control device may be configured to be directed or guided by voice commands. The processes and steps for the example may be stored as computer-readable instructions on a compatible non-transitory computer-readable medium of a computer program product. Computer-readable instructions include a set of operations to be performed on a computer, and may represent pieces of a whole program or individual, separable, software modules. For example, computer-readable instructions include computer program code (source or object code) and “hard-coded” electronics (i.e. computer operations coded into a computer chip). The computer-readable instructions may be stored on any non-transitory computer-readable medium, such as in the memory of a computer or on external storage devices. The instructions are encoded on a non-transitory computer-readable medium.

A number of example embodiments have been described. Nevertheless, it will be understood that various modifications may be made without departing from the spirit and scope of the devices and methods described herein.

What is claimed is:

1. An autonomous vehicle comprising:
a sensor for providing perception data that captures scene images of detected objects during a sequence of frames;
a speed and steering control system;
memory comprising at least one model object class having a model multi-modal embedding space cluster and a model similarity measure boundary; and
an autonomous vehicle controller comprising:
an object detector configured to process each captured scene image to generate a feature probe signal for each of the detected objects, the feature probe signal representing object features comprising an object localization and an object classification associated with the object localization at each frame;
an object relations generator configured to process the object localization to generate a relation probe signal for each of the detected objects, the relation probe signal representing object relations that satisfy a relations confidence threshold;
an object attributes generator configured to process the object localization to generate an attribute probe signal for each of the detected objects, the attribute probe signal representing object attributes that satisfy an attributes confidence threshold;
a similarity measure generator configured to (i) integrate the feature probe signal, the relation probe signal, and the attribute probe signal into a temporal sequence of multi-modal signals, (ii) select dominant multi-modal signals from the temporal sequence of multi-modal signals which satisfy a signal magnitude and time window threshold, and (iii) compare the selected dominant multi-modal signals to the model multi-modal embedding space cluster to generate a sequence of multi-modal temporal similarity measures associated with the sequence of frames;
an object classification verifier configured to compare the sequence of multi-modal temporal similarity measures to the model similarity measure boundary to generate object recognition verification data associated with the object classification; and
an autonomous decision-making system configured to process the object recognition verification data for generating a decision-making command;
wherein the speed and steering control system is configured to processes the decision-making command to autonomously maneuver the autonomous vehicle.

2. The autonomous vehicle of claim 1, wherein the object recognition verification data identifies the object classification (i) as a false positive classification when the sequence of multi-modal temporal similarity measures does not satisfy the model similarity measure boundary and (ii) as a true positive classification when the sequence of multi-modal temporal similarity measure satisfies the model similarity measure boundary.

3. The autonomous vehicle of claim 1, wherein:
the memory comprises a set of model object classes, each model object class in the set of model object classes having an associated set of a model multi-modal embedding space cluster and a model similarity measure boundary; and
a model object class from the set of model object classes is selected based on the object classification from the object detector.

4. The autonomous vehicle of claim 1, wherein each of the multi-modal signals in the temporal sequence of multi-modal signals has a respective temporal window that corresponds to one of the feature probe signal, the relation probe signal, or the attribute probe signal.

5. The autonomous vehicle of claim 1, wherein:
the model multi-modal embedding space cluster comprises a model true positive cluster and a model false positive cluster in a temporal embedding space;
the selected dominant multi-modal signals are mapped to a point in the temporal embedding space;
the similarity measure generator is configured to (i) compare the selected dominant multi-modal signals to the model true positive cluster to determine a true positive distance measure and (ii) compare the selected dominant multi-modal signals to the model false positive cluster to determine a false positive distance measure; and
the multi-modal temporal similarity measure is a ratio of the true positive distance and the false positive distance at each frame.

6. The autonomous vehicle of claim 1, wherein:
the memory further comprises a model observation time constraint;
the object classification verifier is configured to compare the sequence of multi-modal temporal similarity measures during the model observation time constraint to the model similarity measure boundary for generating the object recognition verification data associated with the object classification.

7. The autonomous vehicle of claim 6, wherein:
the sequence of frames has a current frame and prior frames;
the model observation time constraint comprises an observation start time tₛₜₐᵣₜ and an observation end time t_{end}; and
the object recognition verification data represents a validation measurement for the object classification at the current frame, the validation measurement is a comparison of (i) the sequence of similarity measures at the current frame and the prior frames within the observation start time tₛₜₐᵣₜ and the observation end time t_{end} and (ii) the model temporal similarity measure boundary associated with the model object class.

8. The autonomous vehicle according to claim 7, wherein the validation measurement for the object classification is a verified classification when the sequence of similarity measures associated with the detected object at the current frame and the prior frames during the model observation time constraint is within the modal temporal similarity measure boundary associated with the model object class.

9. The autonomous vehicle according to claim 7, wherein:
the validation measurement for the object classification at the current frame is determined from combined similarity measures and probabilistic signal temporal logic constraints based on (i) the sequence of similarity measures during the current frame and the prior frames within model observation time constraint and (ii) the model temporal similarity boundary associated with the model object class;
the validation measurement represents a verified classification at the current frame when the sequence of similarity measures associated with the detected object during the model observation time constraint is within the model temporal similarity measure boundary; and
the validation measurement represents a misclassification at the current frame when the sequence of similarity measures associated with the detected object during the model observation time constraint is not within the model temporal similarity measure boundary.

10. The autonomous vehicle according to claim 9, wherein the combined similarity measures with probabilistic signal temporal logic constraints are generated as follows:
$$∀ z , Pr ( SM ( z , {t}_{start} : {t}_{end} ) \leq {SM}_{boundary} \to the model object class )$$
where:
Pr(⋅) is a predicate;
SM(z, tₛₜₐᵣₜ, t_{end}) is the observation z of the sequence of similarity measures SM during a sequence of frames including the current frame and the prior frames within the model observation time constraint associated with the model object class;
SM_boundary represents performance characteristics from model similarity measure sequences within the model observation time constraint for the selected model object class, where the performance characteristics reflect verified object detection characteristics for instances of similarity measure sequences within the time constraint associated with model object class; and
the symbol “≤” refers to SM(z, tₛₜₐᵣₜ, t_{end}) being within SM_boundary for determining the validation measurement associated with the object classification at the current frame.

11. A method of verifying object classification in a perception system, the method comprising the steps of:
storing at least one model object class having a model multi-modal embedding space cluster and a model similarity measure boundary;
receiving perception data that captures scene images of detected objects during a sequence of frames;
generating a feature probe signal for each of the detected objects in the captured scene images, the feature probe signal representing object features comprising an object localization and an object classification associated with the object localization at each frame;
generating a relation probe signal and an attribute probe signal based on the object localization for each of the detected objects, the relation probe signal representing object relations that satisfy a relations confidence threshold and the attribute probe signal representing object attributes that satisfy an attributes confidence threshold;
integrating the feature probe signal, the relation probe signal, and the attribute probe signal into a temporal sequence of multi-modal signals;
selecting dominant multi-modal signals from the temporal sequence of multi-modal signals which satisfy a signal magnitude and time window threshold;
comparing the selected dominant multi-modal signals to the model multi-modal embedding space cluster to generate a sequence of multi-modal temporal similarity measures associated with the sequence of frames;
comparing the sequence of multi-modal temporal similarity measures to the model similarity measure boundary to generate object recognition verification data associated with the object classification;
generating a decision-making command based on the object recognition verification data; and
controlling the perception system in response to the decision-making command.

12. The method of verifying object classification in a perception system according to claim 11, wherein the perception system is embedded in an autonomous vehicle that includes (i) a sensor and (ii) a speed and steering control system, and the step of controlling the perception system includes controlling the speed and control system in response to the decision-making command for autonomously maneuvering the autonomous vehicle.

13. The method of verifying object classification in a perception system according to claim 11, wherein the perception system is embedded in an autonomous security system that includes a surveillance system, and the step of controlling the perception system includes controlling the surveillance system in response to the decision-making command for autonomously controlling the aviation security system.

14. The method of verifying object classification in a perception system according to claim 11, wherein the object recognition verification data identifies the object classification (i) as a false positive classification when the multi-modal temporal similarity measure does not satisfy the model similarity measure boundary and (ii) as a true positive classification when the multi-modal temporal similarity measure satisfies the model similarity measure boundary.

15. The method of verifying object classification in a perception system according to claim 11, wherein:
the at least one model object class is a set of model object classes, each model object class in the set of model object classes having an associated set of a multi-modal embedding space cluster and a model similarity measure boundary; and
a model object class from the set of model object classes is selected based on the object classification.

16. The method of verifying object classification in a perception system according to claim 11, wherein:
the model multi-modal embedding space cluster comprises a model true positive cluster and a model false positive cluster in a temporal embedding space;
the selected multi-modal signals are mapped to a point in the temporal embedding space;
the selected multi-modal signals are compared to (i) the model true positive cluster to determine a true positive distance measure and (ii) the model false positive cluster to determine a false positive distance measure; and
the multi-modal temporal similarity measure is a ratio of the true positive distance and the false positive distance.

17. The method of verifying object classification in a perception system according to claim 11, the method further comprising:
storing a model observation time constraint associated with the at least one model object class; and
comparing the sequence of multi-modal temporal similarity measures during the model observation time constraint to the model similarity measure boundary for generating the object recognition verification data associated with the object classification.

18. The method of verifying object classification in a perception system according to claim 17, wherein:
the sequence of frames has a current frame and prior frames;
the model observation time constraint comprises an observation start time tₛₜₐᵣₜ and an observation end time t_{end}; and
the object recognition verification data represents a validation measurement for the object classification at the current frame, the validation measurement is a comparison of (i) the sequence of similarity measures at the current frame and the prior frames within the observation start time tₛₜₐᵣₜ and the observation end time t_{end} and (ii) the model temporal similarity measure boundary associated with the at least one model object class.

19. The method of verifying object classification in a perception system according to claim 18, wherein the validation measurement for the object classification is a verified classification when the sequence of similarity measures associated with the detected object at the current frame and the prior frames during the model observation time constraint is within the modal temporal similarity measure boundary associated with the at least one model object class.

20. The method of verifying object classification in a perception system according to claim 18, wherein:
the validation measurement for the object classification at the current frame is determined from combined similarity measures and probabilistic signal temporal logic constraints based on (i) the sequence of similarity measures during the current frame and the prior frames within model observation time constraint; and (ii) the model temporal similarity boundary associated with the at least one model object class;
the validation measurement represents a verified classification at the current frame when the sequence of similarity measures associated with the detected object during the model observation time constraint is within the model temporal similarity measure boundary; and
the validation measurement represents a misclassification at the current frame when the sequence of similarity measures associated with the detected object during the model observation time constraint is not within the model temporal similarity measure boundary.

21. The method of verifying object classification in a perception system according to claim 20, wherein the combined similarity measures with probabilistic signal temporal logic constraints are generated as follows:
$$∀ z , Pr ( SM ( z , {t}_{start} : {t}_{end} ) \leq {SM}_{boundary} \to the model object class )$$
where:
Pr(⋅) is a predicate;
SM(z, tₛₜₐᵣₜ, t_{end}) is the observation z of the sequence of similarity measures SM during a sequence of frames including the current frame and the prior frames within the model observation time constraint associated with the model object class;
SM_boundary represents performance characteristics from model similarity measure sequences within the model observation time constraint for the selected model object class, where the performance characteristics reflect verified object detection characteristics for instances of similarity measure sequences within the time constraint associated with model object class; and
the symbol “S” refers to SM(z, tₛₜₐᵣₜ, t_{end}) being within SM_boundary for determining the validation measurement associated with the object classification at the current frame.

22. A computer system for developing model parameters to verify object recognition, the computer system comprising:
an object detector, an object relations generator, and an object attributes generator that are configured to respectively generate a (i) a training feature probe signal, a training relation probe signal, and a training attribute probe signal for each detected object in scene images from a training data set for a selected model object class and (ii) a testing feature probe signal, a testing relation probe signal, and a testing attribute probe signal for each detected object in scene images from a testing data set for the selected model object class;
a multi-modal signal generator that is configured to process the training feature probe signal, the training relation probe signal, and the training attribute probe signal to (i) generate a training temporal sequence of integrated multi-modal signals and (ii) select training multi-modal signals from the training temporal sequence of integrated multi-modal signals;
a true positive and false positive verifier that is configured to process the selected training multi-modal signals to generate model parameters for the selected model object class based on ground truth data, the model parameters comprising (i) a model multi-modal embedding space cluster comprising a model true positive cluster and a model false positive cluster: (ii) a model similarity measure boundary; and (iii) a model observation time constraint;
a temporal similarity measure generator configured to process the testing feature probe signal, the testing relation probe signal, and the testing attribute probe signal to (i) generate a testing temporal sequence of integrated multi-modal signals: (ii) select testing multi-modal signals from the testing temporal sequence of integrated multi-modal signals; and (iii) compare the selected testing multi-modal signals to the model true positive cluster and the model false positive cluster to generate a testing sequence of temporal similarity measures; and
an object classification verifier configured to compare the testing sequence of temporal similarity measures within the model observation time constraint to the model similarity measure boundary to generate an object recognition verification data;
wherein the object recognition verification data is compared to the ground truth data to determine a testing accuracy percentage, and the model parameters for the selected model object class are verified if the testing accuracy percentage satisfies a validation threshold.

23. The computer system of claim 21, wherein:
the training temporal sequence of integrated multi-modal signals has temporal windows that each corresponds to one of the training feature probe signal, the training relation probe signal, or the training attribute probe signal; and
the testing temporal sequence of integrated multi-modal signals has temporal windows that each corresponds to one of the testing feature probe signal, the testing relation probe signal, or the testing attribute probe signal.

24. The computer system of claim 23, wherein the selected training multi-modal signals and the selected testing multi-modal signals each satisfy a signal magnitude and time window threshold.

25. The computer system of claim 22, wherein, in the training phase:
the selected training multi-modal signals are mapped as a training point in the temporal embedding space, the training point having a true positive label or false positive label based on ground truth data and the temporal embedding space having axes that represent a temporal window duration, a temporal window location, and a multi-modal signal index; and
the multi-modal signal index is rearranged to maximize separation distance between the model true positive cluster containing true positive points and a model false positive cluster containing false positive points in the temporal embedding space.

26. The computer system of claim 22, wherein, in the testing phase:
the selected testing multi-modal signals are mapped to a point in the temporal embedding space;
the similarity measure generator is configured to (i) compare the selected testing multi-modal signals to the model true positive cluster to determine a true positive distance measure and (ii) compare the selected testing multi-modal signals to the model false positive cluster to determine a false positive distance measure; and
the multi-modal temporal similarity measure is a ratio of the true positive distance and the false positive distance.
